(19) United States
(12) Patent Application Publication
(10) Pub. No.: US 2008/0013849 A1
(43) Pub. Date: Jan. 17, 2008

(54) Video Processor Comprising a Sharpness Enhancer

(75) Inventors: Antoine Chouly, Paris (FR); Estelle Lesellier, Meudon (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/573,569

(22) PCT Filed: Aug. 9, 2005
(86) PCT No.: PCT/IB05/52641

§ 371 Date: Feb. 12, 2007

(30) Foreign Application Priority Data
Aug. 16, 2004 (EP) 04300543.8

(51) Int. Cl. G06T 5/20; G06K 9/40

(52) U.S. Cl. 382/254; 358/3.27; 382/260

(57) ABSTRACT

A video processor processes an image that comprises block of pixels. The video processor comprises a sharpness enhancer (ENH). The sharpness enhancer establishes an output pixel (Yo) on the basis of various input pixels (Yi) within an adaptive filter window. The adaptive filter window exclusively comprises input pixels that form part of the same block of pixels.

### FIELD OF THE INVENTION

An aspect of the invention relates to a video processor that comprises a sharpness enhancer. The video processor may be implemented in the form of, for example, a suitably programmed multi-purpose microprocessor. Other aspects of the invention relate to a method of processing an image, a computer program product for a video processor, and a video-rendering apparatus. The video-rendering apparatus may be, for example, a cellular phone or a personal digital assistant (PDA).

### BACKGROUND OF THE INVENTION

U.S. Pat. No. 4,571,635 describes a method of enhancing images. A point-by-point record of an image is made with successive pixels in a logical array. The standard deviation of the pixels is determined. In addition, an effective central pixel value is determined. An image is displayed or recorded using the determined central pixel values. The image will show enhanced detail relative to an original image.

### SUMMARY OF THE INVENTION

According to an aspect of the invention, a video processor has the following characteristics. The video processor processes an image that comprises blocks of pixels. The video processor comprises a sharpness enhancer. The sharpness enhancer establishes an output pixel on the basis of various input pixels within an adaptive filter window. The adaptive filter window exclusively comprises input pixels that form part of the same block of pixels.

The invention takes the following aspects into consideration. Block-wise composition of an image is typical for many video encoding techniques. MPEG2 and MPEG4 are examples. At an encoding end, an image to be encoded is divided into blocks of pixels. Each of these blocks is encoded individually. Each encoding step will introduce a certain encoding error. Consequently, the encoding error may differ from one block to another. Two adjacent blocks may have different encoding errors. A block effect may occur if the respective coding errors differ to a relatively great extent. Sufficiently visible blocks may appear in a decoded image that is displayed on a display device. This degrades subjective image quality.

A sharpness enhancer typically enhances differences between a certain pixel and neighboring pixels. Such differences may originate from an original image as captured by a camera, for example. However, such differences may also be due to coding artifacts as described hereinbefore. A sharpness enhancer may cause coding artifacts, such as block effects, to become more visible. Let it be assumed, for example, that the prior-art sharpness enhancer, which has been identified hereinbefore, is used for enhancing an MPEG2 or MPEG4 decoded image. There is a serious risk that the enhanced image will be perceived as having a lesser quality compared with the decoded image that has not been enhanced. In popular terms, the medicine may be worse than the illness. This is particularly true in cases where high video compression rates are applied because coding errors will be significant in such cases.

In accordance with the aforementioned aspect of the invention, the sharpness enhancer establishes an output pixel on the basis of various input pixels within an adaptive filter window that exclusively comprises input pixels forming part of the same block of pixels.

Accordingly, the invention prevents amplification of a difference that may exist between a block of pixels and an adjacent block of pixels. As explained hereinbefore, such a difference will generally be due to coding errors. Consequently, the invention prevents that coding errors are amplified and degrade image quality as perceived by human beings. However, the invention allows amplification of differences between a certain pixel and neighboring pixels within the same block. Such differences generally originate from the original image. Consequently, sharpness enhancement in accordance with the invention will generally enhance details from the original image rather than enhancing coding artifacts. For those reasons, the invention allows improved image quality, in particular in cases where high video compression rates are applied.

These and other aspects of the invention will be described in greater detail hereinafter with reference to drawings.

### BRIEF DESCRIPTION OF THE DRAWINGS

FIG. 1 is a block diagram that illustrates a portable video apparatus.

FIG. 2 is a block diagram that illustrates a video processor.

FIG. 3 is a functional diagram that illustrates operations that the video processor carries out.

FIG. 4 is a diagram that illustrates an image comprising blocks of pixels.

FIG. 5 is a functional diagram that illustrates a sharpness enhancer that forms part of the video processor.

FIG. 6 is a functional diagram that illustrates a peaking filter that forms part of the sharpness enhancer.

FIG. 7 is a graph that illustrates a clipping operation for high-pass filtered input pixels.

FIGS. 8A, 8B, and 8C are diagrams that illustrate a filtering operation for a pixel that is relatively distant from a block boundary.

FIGS. 9A, 9B, and 9C are diagrams that illustrate a filtering operation for a pixel that forms part of a vertical block boundary.

FIGS. 10A, 10B, and 10C are diagrams that illustrate a filtering operation for a pixel that forms part of a horizontal block boundary.

### DETAILED DESCRIPTION

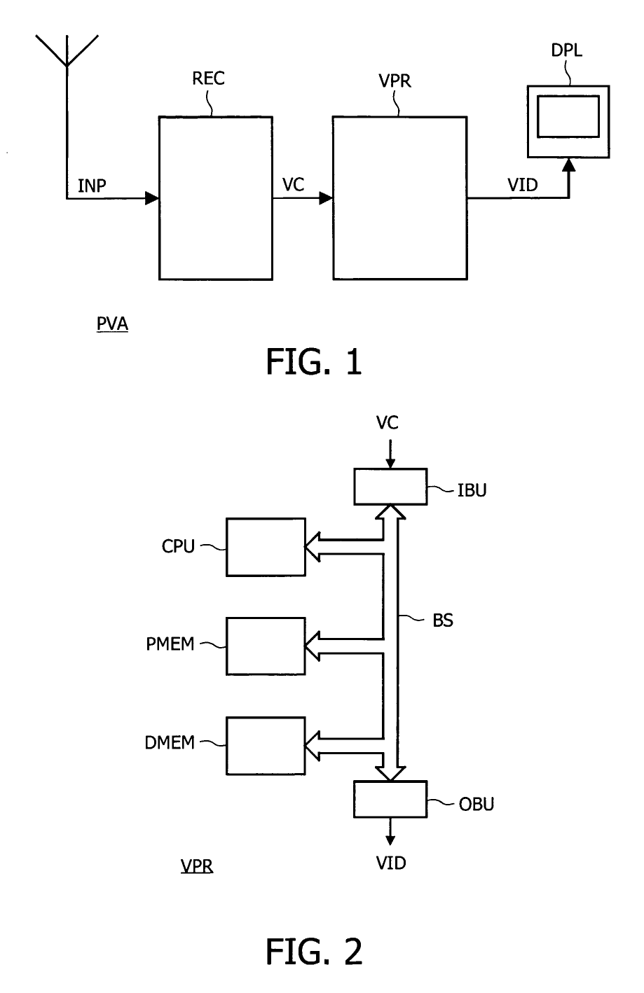

FIG. 1 illustrates a portable video apparatus PVA, which may be, for example, a cellular phone. The portable video apparatus PVA comprises a receiver REC, a video processor VPR, and a display device DPL. The receiver REC retrieves a coded video signal VC from a received input signal INP. The coded video signal VC results from an encoding step performed at a transmitting end on a sequence of images. The coded video signal VC may also result from an encoding step of a single image, a so-called still picture. The coded video signal VC may be, for example, an MPEG4 transport stream. The video processor VPR retrieves a video signal VID from the coded video signal VC that the receiver REC provides. The display device DPL displays the video signal VID.

FIG. 2 illustrates the video processor VPR. The video processor VPR comprises an input buffer IBU, a processing circuit CPU, a program memory PMEM, a data memory DMEM, an output buffer OBU, and a bus BS, which couples the aforementioned elements to each other. The video processor VPR carries out various different operations. The program memory PMEM comprises a set of instructions, i.e. software, which causes the processing circuit CPU to effect these various different operations. The data memory DMEM stores intermediate results of the operations. An operation may be defined by a software module, such as, for example, a subroutine.

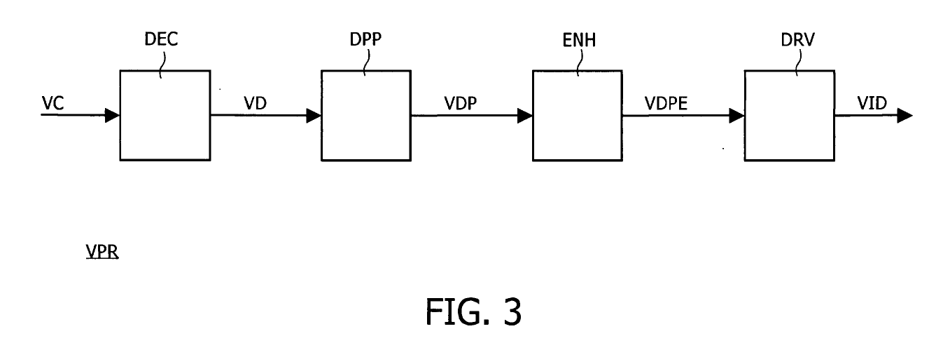

FIG. 3 is a functional diagram of the video processor VPR, which illustrates the operations that the video processor VPR carries out. In FIG. 3, operations, or functions, are represented as blocks. A block may thus correspond to a software module in the form of, for example, a subroutine. The various blocks will be described hereinafter as if they were functional entities for reasons of ease of description.

FIG. 3 illustrates that the video processor VPR comprises the following functional entities: a video decoder DEC, a decoding postprocessor DPP, a sharpness enhancer ENH, and a video driver DRV. The video decoder DEC decodes the coded video signal VC so as to obtain a decoded video signal VD. The video decoder DEC may be, for example, compliant with the MPEG4 standard so as to decode the aforementioned MPEG4 transport stream.

The decoding postprocessor DPP processes the decoded video signal VD so as to attenuate certain artifacts that are related to the video coding technique by means of which the coded video signal VC has been obtained. For example, in the case of MPEG4 video coding, such artifacts may include so-called blocking and ringing effects that degrade image quality as perceived by human beings. The decoding postprocessor DPP provides a post-processed decoded video signal VDP in which such blocking and ringing effects are attenuated.

The sharpness enhancer ENH processes the post-processed decoded video signal VDP so as to enhance the sharpness of images that the coded video signal VC represents. The decoding postprocessor DPP and the sharpness enhancer ENH thus improve the subjective quality of images displayed on the display device DPL illustrated in FIG. 1. The video driver DRV receives an enhanced post-processed decoded video signal VDPE from the, sharpness enhancer ENH and processes this signal for delivering the video signal VID, for the purpose of display on the display device DPL. This processing may include, for example, video format conversion, amplification, and contrast, brightness and color adjustments.

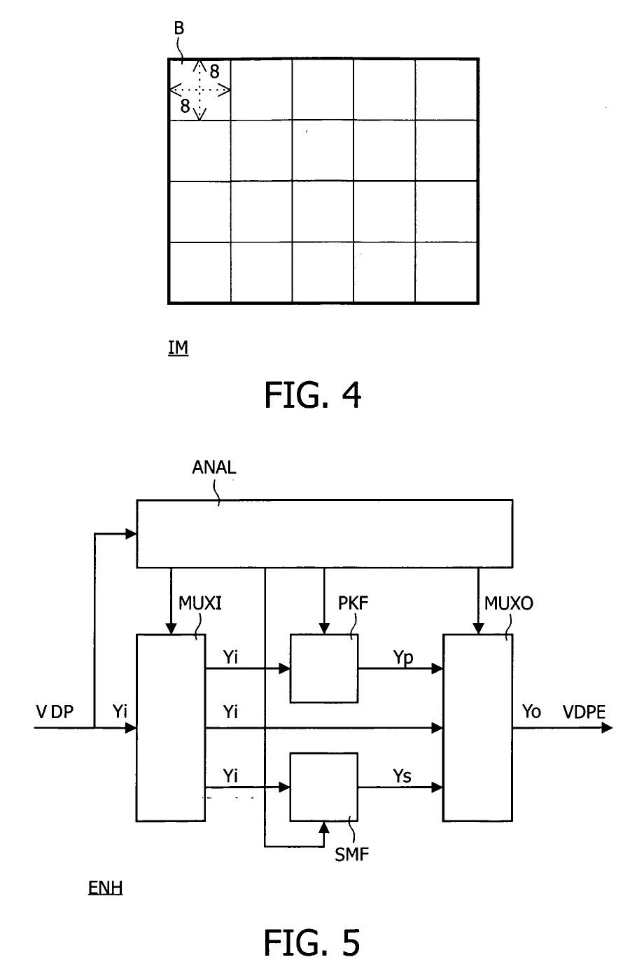

FIG. 4 illustrates an image IM in the video signal VID for display on the display device DPL. The image is formed by various blocks of pixels B. A block can be regarded as a matrix of 64 pixels, the matrix having 8 rows and 8 columns. This block-wise composition of an image is typical for many video encoding techniques. MPEG2 and MPEG4 are examples. At an encoding end, an image to be encoded is divided into blocks of pixels. Each of these blocks is encoded individually.

In the video processor VPR, which is illustrated in FIG. 3, the decoded video signal VD can be regarded as a stream of blocks of pixels. The same applies to the post-processed decoded video signal VDP and the enhanced post-processed decoded video signal VDPE. The decoding postprocessor DPP may comprise, for example, a memory for temporarily storing a block of pixels and blocks of pixels adjacent thereto. This memory will physically form part of the data memory DMEM, which is illustrated in FIG. 2. A set of memory locations, defined by addresses, within the data memory DMEM is statically or dynamically assigned to the decoding postprocessor DPP. The same applies to the sharpness enhancer ENH.

FIG. 5 illustrates the sharpness enhancer ENH. The sharpness enhancer ENH comprises a video analyzer ANAL, an input multiplexer MUXI, a peaking filter PKF, a smoothing filter SMF, and an output multiplexer MUXO. The sharpness enhancer ENH processes pixels within a block on a pixel by pixel basis. That is, the sharpness enhancer ENH establishes an output pixel Yo for each input pixel Yi. The output pixel Yo may be a peaked pixel Yp, a smoothed pixel Ys, or the output pixel Yo may be identical to the input pixel Yi. The peaking filter PKF provides the peaked pixel Yp. The smoothing filter SMF provides the smoothed pixel Ys. The peaking filter PKF can be associated with a high-pass filter, whereas the smoothing filter SMF can be associated with a low-pass filter.

The video analyzer ANAL controls the input and output multiplexers MUXI and MUXO. Accordingly, the video analyzer ANAL determines which processing is applied to the input pixel Yi : the peaking filter PKF, the smoothing filter SMF, or just a straight line, which symbolizes that the output pixel Yo is identical to the input pixel Yi. The video analyzer ANAL may further control the peaking filter PKF and the smoothing filter SMF.

The video analyzer ANAL calculates a variance for a pixel area of which the input pixel Yi forms part. The pixel area may be, for example, a window of 3 by 3 pixels, the input pixel Yi typically being the central pixel. The variance indicates whether the pixels within the pixel area are correlated or not. Pixels are correlated if the variance has a low value. In that case, the pixel area, of which the input pixel Yi forms part, comprises relatively few details. In other words, the pixel area is rather smooth. Conversely, pixels are relatively uncorrelated if the variance has a high value. In that case, the pixel area, of which the input pixel Yi forms part, comprises relatively many details. Accordingly, the video analyzer ANAL establishes variance for each input pixel Yi.

Let it be assumed that the video analyzer ANAL establishes that the variance for the input pixel Yi has a relatively high value. In that case, the video analyzer ANAL causes the peaking filter PKF to process the input pixel Yi. The peaked pixel Yp that results from this processing constitutes the output pixel Yo of the sharpness enhancer ENH. Conversely, the video analyzer ANAL may cause the smoothing filter SMF to process the input pixel Yi if the variance for the input pixel Yi has a relatively low value. Alternatively, the video analyzer ANAL may also cause the output pixel Yo to be identical to the input pixel Yi. The video analyzer ANAL may further adjust characteristics of the peaking filter PKF and the smoothing filter SMF as a function of the variance.

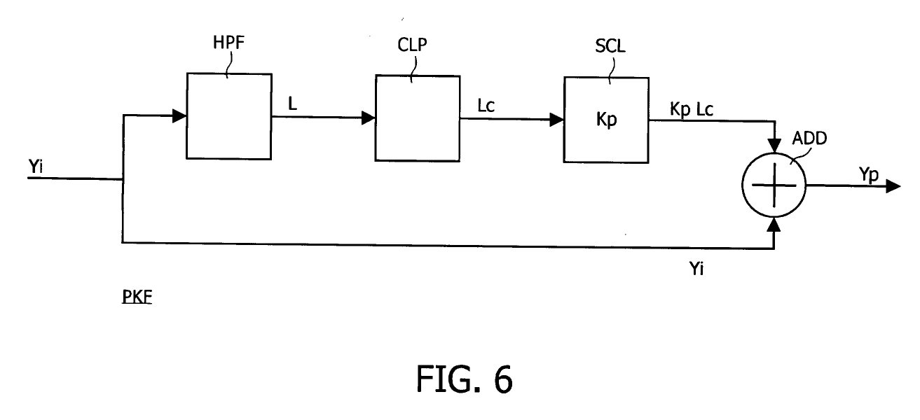

FIG. 6 illustrates the peaking filter PKF which forms part of the sharpness enhancer ENH illustrated in FIG. 5. The peaking filter PKF comprises a high-pass filter HPF, a clipper CLP, a scaler SCL, and an adder ADD. The high-pass filter HPF receives pixels that lie within a filter window. The filter window comprises the input pixel Yi and neighboring pixels. The filter window will be described in greater detail hereinafter.

The high-pass filter HPF provides a high-pass filtered pixel L. The high-pass filtered pixel L is a weighed combination of the pixels that lie within the filter window. The clipper CLP provides a clipped high-pass filtered pixel Lc. The scaler SCL scales the clipped high-pass filtered pixel Lc so as to obtain a clipped-and-scaled high-pass filtered pixel KpLc. The adder ADD adds the clipped-and-scaled high-pass filtered pixel KpLc to the input pixel Yi. Accordingly, the peaked pixel Yp is obtained. A negative value of the high-pass filtered pixel L will cause the peaked pixel Yp to be darker than the input pixel Yi. This can be regarded as a dark shift. Conversely, a positive value of the high-pass filtered pixel L will cause the peaked pixel Yp to be brighter than the input pixel Yi. This corresponds to a bright shift.

FIG. 7 illustrates a transfer function of the clipper CLP. The horizontal axis represents the value of the high-pass filtered pixel L that the clipper CLP receives. The vertical axis represents the value of the clipped high-pass filtered pixel Lc that the clipper CLP provides. FIG. 7 illustrates that the clipper CLP defines a desired range of values for the high-pass filtered pixel L. The desired range lies between a negative clipping value NCL and a positive clipping value PCL. The clipper CLP provides a clipped high-pass filtered pixel Lc whose value is identical to that of the high-pass filtered pixel L if the value of this pixel lies within the desired range. The clipped high-pass filtered pixel Lc has the negative clipping value NCL if the high-pass filtered pixel L is below the negative clipping value NCL or equal thereto. This limits the dark shift. Conversely, the clipped high-pass filtered pixel Lc has the positive clipping value PCL if the high-pass filtered pixel L is above the positive clipping value PCL or equal thereto. This limits the bright shift. Too much dark shift or too much bright shift, or both, can cause an image to be perceived as unnatural. The clipper CLP, which limits the dark shift and the bright shift, accounts for this.

FIG. 7 illustrates that the positive clipping value PCL has a lower magnitude than the negative clipping value NCL. The transfer function is asymmetrical with respect to zero. It has empirically been established that human vision is more sensitive to a bright shift than to a dark shift. Too much bright shift can cause an image to be perceived as unnatural. Such risk is somewhat less in the case of a dark shift. The clipper CLP, which has an asymmetrical transfer function as illustrated in FIG. 7, accounts for this.

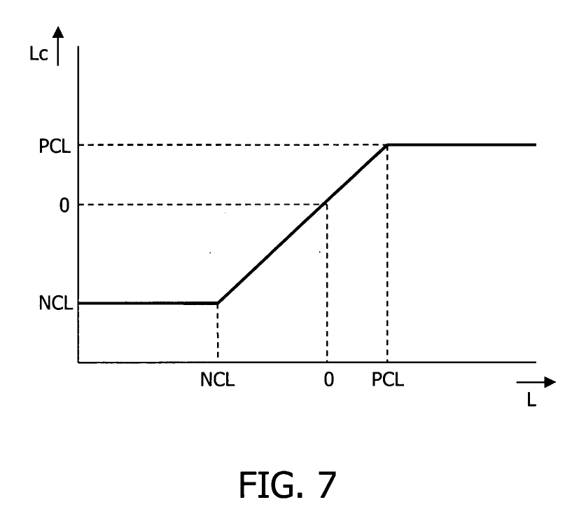

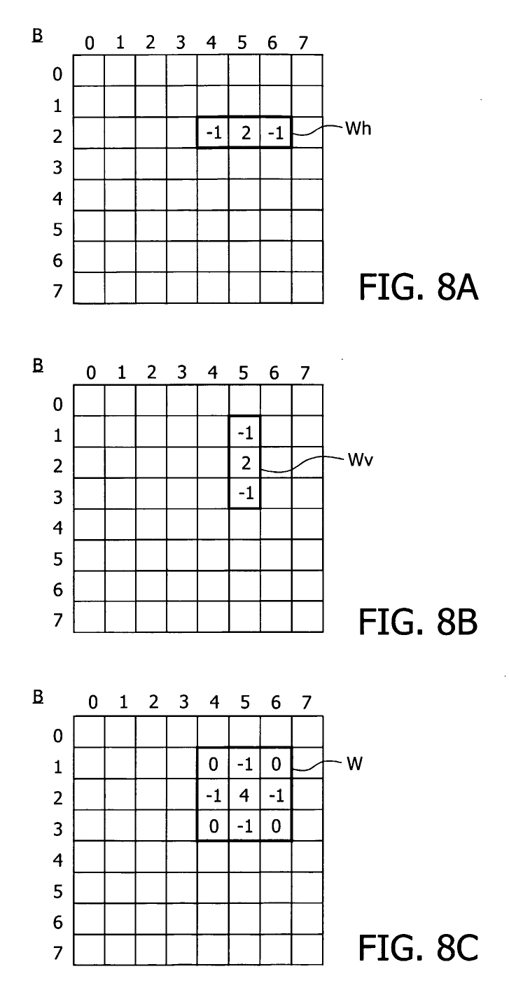

FIGS. 8A-8C, 9A-9C, and 10A-10C illustrate the manner in which the high-pass filter HPF, which is illustrated in FIG. 6, establishes high-pass filtered pixels L. Each of the aforementioned figures illustrates a block B of 8 by 8 pixels. The rows and columns of pixels are numbered from 0 to 7. This numbering allows identification of each individual input pixel Yi by means of coordinates. For example, the input pixel Yi that is in row number 5 and in column number 2 is designated as Yi(5,2).

As mentioned hereinbefore, the high-pass filter HPF makes a weighed combination of the pixels that lie within the filter window. The filter window comprises a horizontal filter window Wh and a vertical filter window Wv. FIGS. 8A, 9A, and 10A illustrate the horizontal filter window Wh. FIGS. 8B, 9B, and 10B illustrate the vertical filter window Wv. FIGS. 8C, 9C, and 10C illustrate the filter window W, which results from a combination of the horizontal filter window Wh and the vertical filter window Wv. In the figures, numerals are present in the respective filter windows. These numerals represent filter coefficients.

The horizontal filter window Wh comprises a center pixel, a left adjacent pixel, and a right adjacent pixel. The filter coefficient for the center pixel is 2. The filter coefficient for the left adjacent pixel and the right adjacent pixel is −1. The vertical filter window Wv comprises a center pixel, an upper adjacent pixel, and a lower adjacent pixel. The filter coefficient for the center pixel is 2. The filter coefficient for the upper adjacent pixel and the lower adjacent pixel is '1.

FIGS. 8A, 8B, and 8C illustrate the manner in which the high-pass filter HPF establishes a high-pass filtered pixel L(5,2) for input pixel Yi(5,2). FIG. 8A illustrates the horizontal filter window Wh. The center pixel of the horizontal filter window Wh coincides with input pixel Yi(5,2). FIG. 8B illustrates the vertical filter window Wv. The center pixel of the vertical filter window Wv also coincides with input pixel Yi(5,2). FIG. 8C shows the filter window for input pixel Yi(5,2). The filter window is a combination of the horizontal filter window Wh and the vertical filter window Wv. The horizontal filter window Wh and the vertical filter window Wv have only input pixel Yi(5,2) in common, which is the center pixel for each of these filter windows. The respective filter coefficients of the horizontal filter window Wh and of the vertical filter window Wv are added. Consequently, the center pixel in the filter window W, which is illustrated in FIG. 8C, has a filter coefficient that is 2+2=4.

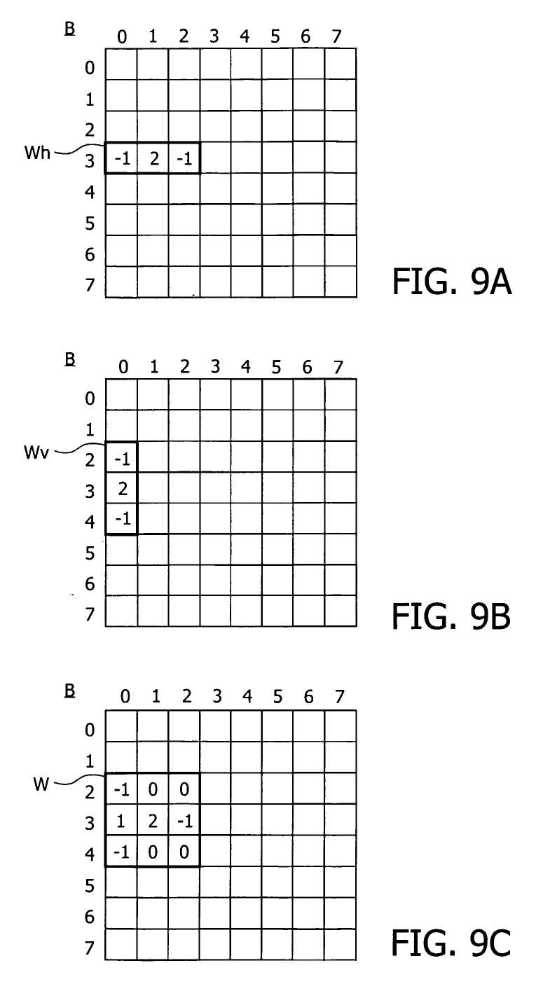

FIGS. 9A, 9B, and 9C illustrate the manner in which the high-pass filter HPF establishes a high-pass filtered pixel L(0,3) for input pixel Yi(0,3). Input pixel Yi(0,3) forms part of a vertical boundary of the block of pixels. FIG. 9A illustrates the horizontal filter window Wh. The center pixel of the horizontal filter window Wh does not coincide with input pixel Yi(0,3). Otherwise, the horizontal filter window Wh would include a pixel of a left neighboring block of pixels, which is to be prevented. The horizontal filter window Wh is positioned so that it includes only input pixels that belong to the same block of which input pixel Yi(0,3) forms part. It can be said that the horizontal filter window Wh is stopped against the left vertical boundary of the block of pixels. Likewise, the horizontal filter window Wh will be stopped against the right vertical boundary of the block of pixels. It should be noted that the horizontal filter window Wh illustrated in FIG. 9A has the same position as for establishing a high-pass filtered pixel L(1,3) for input pixel Yi(1,3).

FIG. 9B illustrates the vertical filter window Wv. The center pixel of the vertical filter window Wv coincides with input pixel Yi(0,3).

FIG. 9C shows the filter window W for the input pixel Yi (0,3). The filter window W is a combination of the horizontal filter window Wh and the vertical filter window Wv. The horizontal filter window Wh and the vertical filter window Wv have only input pixel Yi(0,3) in common, which is the left adjacent pixel for the horizontal filter window Wh and the center pixel for the vertical filter window Wv. The respective filter coefficients of the horizontal filter window Wh and of the vertical filter window Wv are added. Consequently, the pixel that is the left neighbor of the center pixel in the filter window W, which is illustrated in FIG. 8C, has a filter coefficient that is 2−1=1.

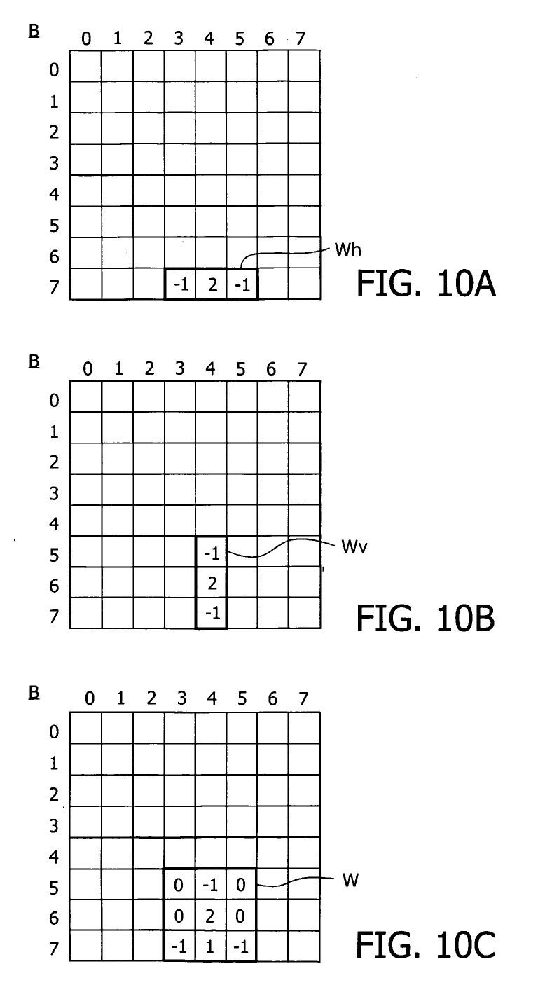

FIGS. 10A, 10B, and 10C illustrate the manner in which the high-pass filter HPF establishes a high-pass filtered pixel L(4,7) for input pixel Yi(4,7). Input pixel Yi(4,7) forms part of a horizontal boundary of the block of pixels. FIG. 10A illustrates the horizontal filter window Wh. The center pixel of the horizontal filter window Wh coincides with input pixel Yi(4,7).

FIG. 10B illustrates the vertical filter window Wv. The center pixel of the vertical filter window Wv does not coincide with input pixel Yi(4,7). Otherwise, the vertical filter window Wv would include a pixel of a lower neighboring block of pixels, which is to be prevented. The vertical filter window Wv is positioned so that it includes only input pixels that belong to the same block of which input pixel Yi(4,7) to be filtered forms part. It can be said that the vertical filter window Wv is stopped against the lower horizontal boundary of the block of pixels. Likewise, the vertical filter window Wv will be stopped against the upper horizontal boundary of the block of pixels. It should be noted that the vertical filter window Wv illustrated in FIG. 10B has the same position as for establishing a high-pass filtered pixel L(4,6) for input pixel Yi(4,6).

FIG. 10C shows the filter window W for input pixel Yi(4,7). The filter window W is a combination of the horizontal filter window Wh and the vertical filter window Wv. The horizontal filter window Wh and the vertical filter window Wv have only input pixel Yi(4,7) in common, which is the center pixel for the horizontal filter window Wh and the lower adjacent pixel for the vertical filter window Wv. The respective filter coefficients of the horizontal filter window Wh and the vertical filter window Wv are added. Consequently, the pixel that is the lower neighbor of the center pixel in the filter window W, which is illustrated in FIG. 8C, has a filter coefficient that is 2−1=1.

Concluding Remarks

The detailed description hereinbefore with reference to the drawings illustrates the following characteristics. A video processor (VPR) processes an image (the coded video signal VC comprises at least one image) that comprises blocks of pixels (FIG. 4 illustrated this). The video processor comprises a sharpness enhancer (ENH) that establishes an output pixel (Yo) on the basis of various input pixels (Yi) within an adaptive filter window (W) that exclusively comprises input pixels that form part of the same block of pixels (FIGS. 8A-8C, 9A-9C, and 10A-10C illustrate this : the filter window W is adapted for input pixels Yi at the boundaries of the block so that the window W remains inside the block).

The detailed description hereinbefore further illustrates the following optional characteristics. The adaptive window (W) is formed by a combination of a horizontal filter window (Wh) and a vertical filter window (Wv). The sharpness enhancer (ENH) stops the horizontal filter window against a vertical boundary of the block of pixels concerned (FIGS. 9A-9C illustrate this). The sharpness enhancer (ENH) further stops the vertical filter window against a horizontal boundary of the block of pixels (FIGS. 10A-10C illustrate this). These characteristics allow implementations with relatively simple hardware or software, or both. Consequently, these characteristics allow cost-efficiency.

The detailed description hereinbefore further illustrates the following optional characteristics. A decoding post-processor (DPP) attenuates blocking artifacts within the image (which is comprised in the coded video signal VC). The sharpness enhancer (ENH) receives input pixels (Yi) from the decoding post-processor. These characteristics further contribute to a satisfactory image quality.

The detailed description hereinbefore further illustrates the following optional characteristics. The sharpness enhancer (ENH) comprises a video analyzer (ANAL) that calculates a variance within a pixel area that comprises an input pixel (Yi) corresponding to the output pixel (Yo). The sharpness enhancer (ENH) establishes the output pixel in one among various different manners (the output pixel Yo can be the peaked pixel Yp that the peaking filter PKF provides, or the smoothed pixel Ys that the smoothing filter SMF provides, or the output pixel Yo can be identical to the input pixel Yi). The manner in which the output pixel is established depends on the variance (the video analyzer ANAL controls the multiplexers MUXI, MUXO). These characteristics further contribute to a satisfactory image quality.

The detailed description hereinbefore further illustrates the following optional characteristics. The sharpness enhancer (ENH) comprises a clipper (CLP) having an asymmetrical transfer function (FIG. 7 illustrates this). Accordingly, the clipper (CLP) limits a dark shift of the output pixel (Yo) to a greater extent than a bright shift of the output pixel. These characteristics further contribute to a satisfactory image quality.

The aforementioned characteristics can be implemented in numerous different manners. In order to illustrate this, some alternatives are briefly indicated.

There are numerous different manners to implement a sharpness enhancer in accordance with the invention. For example, the sharpness enhancer ENH illustrated in FIG. 5. may be modified as follows. All elements are omitted except for the peaking filter PKF, which remains. This is an example of a basic implementation of a sharpness enhancer. Another example involves the following modifications. The output multiplexer MUXO, which is illustrated in FIG. 5, is replaced by an element that makes a weighed combination of the peaked pixel Yp, the smoothed pixel Ys, and the input pixel Yi, so as to obtain the output pixel Yo. The video analyzer ANAL may adjust weighing factors. The decoding postprocessor DPP and the sharpness enhancer ENH may be combined.

There are numerous different manners to implement a peaking filter. For example, the peaking filter PKF illustrated in FIG. 6 may be modified as follows. All elements are omitted except for the high-pass filter HPF. This is an example of a basic implementation of the high-pass filter. In another implementation, the clipper CLP, which is illustrated in FIG. 6, may have a transfer function that provides a so-called soft clipping rather than a hard clipping as illustrated in FIG. 7.

There are numerous different filter windows that provide a satisfactory sharpness enhancement. For example, a filter window may comprise 2-by-2 pixels, or 2 by 3 pixels, or any other size. The filter window may adapt in various different manners. For example, a sharpness enhancer in accordance with the invention may comprise a table that defines a suitable filter window and the coefficients therein, for each pixel within a block. The filter window for pixels at the boundary of the block may be different from the filter window for other pixels.

There are numerous ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A video processor (VPR) for processing an image (VC) that comprises blocks (B) of pixels, the video processor comprising a sharpness enhancer (ENH) being arranged to establish an output pixel (Yo) on the basis of various input pixels (Yi) within an adaptive filter window (W) that exclusively comprises input pixels that form part of the same block (B) of pixels.

2. A video processor as claimed in claim 1, wherein the adaptive window (W) is formed by a combination of a horizontal filter window (Wh) and a vertical filter window (Wv), the sharpness enhancer (ENH) being arranged to stop the horizontal filter window against a vertical boundary of the same block (B) of pixels and to stop the vertical filter window against a horizontal boundary of the same block (B) of pixels.

3. A video processor as claimed in claim 1, further comprising a decoding post-processor (DPP) arranged to attenuate blocking artifacts within the image (VC), the sharpness enhancer (ENH) being coupled to receive input pixels (Yi) from the decoding post-processor.

4. A video processor as claimed in claim 1, wherein the sharpness enhancer (ENH) comprises a video analyzer (ANAL) arranged to calculate a variance within a pixel area that comprises an input pixel (Yi) corresponding to the output pixel (Yo), the sharpness enhancer being arranged to establish the output pixel in various different manners (PKF, SMF), the manner in which the output pixel is established depending on the variance.

5. A video processor as claimed in claim 1, wherein the sharpness enhancer (ENH) comprises a clipper (CLP) having an asymmetrical transfer function so as to limit a bright shift of the output pixel (Yo) to a greater extent than a dark shift of the output pixel.

6. A video processor as claimed in claim 5, wherein the clipper (CLP) is arranged to limit a dark shift of the output pixel (Yo) to a negative clipping value (NCL), and to limit a bright shift of the output pixel to a positive clipping value (PCL), the negative clipping value having a greater magnitude than the positive clipping value.

7. A method of processing an image (VC) that comprises blocks (B) of pixels, the method comprising a sharpness enhancement step (ENH) in which an output pixel (Yo) is established on the basis of various input pixels (Yi) within an adaptive filter window (W) that exclusively comprises input pixels that form part of the same block (B) of pixels.

8. A computer program product for a video processor (VPR) arranged to process an image (VC) that comprises blocks (B) of pixels, the computer program product comprising a set of instructions that, when loaded into the video processor, causes the video processor to carry out a sharpness enhancement step (ENH) in which an output pixel (Yo) is established on the basis of various input pixels (Yi) within an adaptive filter window (W) that exclusively comprises input pixels that form part of the same block (B) of pixels.

9. An image-rendering apparatus (PVA) that comprises a video processor (VPR) as claimed in claim 1, and an image-rendering device (DPL) for rendering the image that the video processor has processed (VID).
